(19) United States
(12) Patent Application Publication
(10) Pub. No.: US 2020/0145551 A1
(43) Pub. Date: May 7, 2020

(54) INFORMATION READING DEVICE

(71) Applicant: NIDEC SANKYO CORPORATION, Nagano (JP)

(72) Inventor: Daigo OGURA, Nagano (JP)

(21) Appl. No.: 16/609,013

(22) PCT Filed: Apr. 10, 2018
(86) PCT No.: PCT/JP2018/015051

§ 371 Date: Oct. 28, 2019

Related U.S. Application Data
(60) Provisional application No. 62/491,588, filed on Apr. 28, 2017.

(30) Foreign Application Priority Data
Aug. 31, 2017 (JP) 2017-166587

(51) Int. Cl. H04N 1/203; H04N 1/024; H04N 1/12; H04N 1/00

(52) U.S. Cl. CPC H04N 1/2032; H04N 1/00551; H04N 1/1225; H04N 1/024

(57) ABSTRACT

An information reading device capable of optically and appropriately reading information recorded on one surface of a first information recording medium having an end portion in which folds and the like are liable to occur, and information recorded on both surfaces of a second information recording medium which has an end portion in which folds and the like are not liable to occur.

### CROSS REFERENCE TO PRIOR APPLICATIONS

The present application is the US national stage under 35 USC § 371 of PCT/JP2018/015051 filed on Apr. 10, 2018 which claimed priority under 35 U.S.C. § 119 to U.S. provisional application 62/491,588 filed Apr. 28, 2017 and also to Japanese Patent Application No. 2017-166587, filed on Aug. 31, 2017, priority of to all of which is also claimed hereto, and the entire contents of all of these previous applications are incorporated herein by reference.

### TECHNICAL FIELD

At least an embodiment of the present invention relates to an information reading device structured to optically read information recorded on an information recording medium.

### BACKGROUND

Conventionally, a passport reader structured to perform processing of a passport has been known (see, for example, Patent Literature 1). The passport reader described in Patent Literature 1 includes a glass window attached on an upper face side of a housing, a first mirror, a second mirror and a camera which are disposed inside the housing. In the passport reader, an image of an under face of a passport placed on the glass window is acquired by the camera. In other words, in the passport reader, information recorded on an under face of a passport which is placed on the glass window is optically read.

### CITATION LIST

[Patent Literature 1] Japanese translation of PCT international application No. 2008-515086

The present inventor has examined a structure of an information reading device which is capable of optically reading informations of two types of information recording media, i.e., an information recording medium whose image information on one side is required, and an information recording medium whose size is smaller than that information recording medium and image informations on both sides are required. For example, the present inventor has examined a structure of an information reading device which is capable of optically reading information recorded on a rear face of a front cover of a passport and informations recorded on both sides of an ID card which is smaller than the passport.

In a case of a passport, an end part of a passport is folded or the like and the end part of the passport may be easily deformed. When an end part of a passport placed on a glass face of an information reading device is deformed, a part of the passport is floated from the glass face and, as a result, a situation may be occurred that information recorded on an under face of the passport cannot be optically read by the information reading device adequately. Further, a passport is formed in a booklet shape and thus, a part of the passport placed on the glass face in an opened state is floated from the glass face and, as a result, a situation is easily occurred that information recorded on an under face of the passport cannot be optically read by the information reading device adequately. Therefore, in order to optically read information recorded on an under face of a passport by an information reading device adequately, the passport is required to be pressed toward a glass face on which the passport is placed. Accordingly, the present inventor has examined to provide a member for pressing down a passport.

On the other hand, in a case of an ID card, an end part of the ID card is hard to be folded or the like in comparison with a passport and a part of the ID card is hard to be floated from the glass face. Therefore, even when an ID card is not pressed toward the glass face on which the ID card is placed, information recorded on an under face of the ID card can be optically read by the information reading device adequately. However, in a case that a member for pressing a passport toward the glass face is provided, when information recorded on an upper face of an ID card is optically to be read, an image of the member for pressing down a passport is captured and thus, there is a fear that information recorded on an upper face of the ID card cannot be optically read adequately.

### SUMMARY

In view of the problem described above, at least an embodiment of the present provides an information reading device structured to optically read information recorded on an information recording medium, the information reading device being capable of optically and adequately reading information recorded on an under face of a first information recording medium like a passport, which is easily floated from a placement member on which the information recording medium is placed, and informations recorded on both sides of a second information recording medium like an ID card which is smaller than the first information recording medium and is hard to be floated from the placement member.

To solve the above-mentioned problem, at least an embodiment of the present invention provides an information reading device structured to optically read information recorded on an information recording medium. The information reading device includes a transparent placement member on which the information recording medium is placed, a first illumination part structured to irradiate an under face of the information recording medium placed on the placement member with light, a second illumination part structured to irradiate an upper face of the information recording medium placed on the placement member with light, a first optical system structured to read information recorded on the under face of the information recording medium placed on the placement member, and a second optical system structured to read information recorded on the upper face of the information recording medium placed on the placement member. In addition, when an inserting direction side of the information recording medium to the information reading device is defined as a rear side, a taking-out direction side of the information recording medium from the information reading device is defined as a front side, an insertion taking-out direction of the information recording medium with respect to the information reading device is defined as a front and rear direction, and a direction perpendicular to an upper and lower direction and the front and rear direction is defined as a right and left direction, the information reading device further includes a pressing member having two pressing parts structured to contact from an upper side with at least parts of both end parts in the right and left direction of a first information recording medium as the information recording medium to press down at least the parts of the both end parts in the right and left direction of the first information recording medium, and a contact member having a contact part structured to contact with a rear end of a second information recording medium as the information recording medium. In addition, a width in the front and rear direction of a portion of the first information recording medium placed on the placement member is wider than a width in the front and rear direction of a portion of the second information recording medium placed on the placement member, a distance in the right and left direction of the two pressing parts is wider than a width in the right and left direction of the second information recording medium and, when the first information recording medium is inserted into the information reading device, the pressing parts press down at least the parts of the both end parts in the right and left direction of the first information recording medium from the upper side and the contact part is moved upward to allow a rear end of the first information recording medium to pass a lower side with respect to the contact part and, when the second information recording medium is inserted into the information reading device, a rear end of the second information recording medium contacts with the contact part.

The information reading device in accordance with at least an embodiment of the present invention includes a pressing member having two pressing parts structured to contact from an upper side with at least parts of both end parts in the right and left direction of a first information recording medium to press down at least the parts of the both end parts in the right and left direction of the first information recording medium and, when the first information recording medium is inserted into the information reading device, the pressing parts press down at least the parts of the both end parts in the right and left direction of the first information recording medium from the upper side. Therefore, according to the present invention, when information recorded on an under face of the first information recording medium is to be optically read, floating of the under face of the first information recording medium from an upper face of the placement member can be suppressed. Accordingly, in the present invention, information recorded on the under face of the first information recording medium which is easily floated from the placement member like a passport can be optically and adequately read. In other words, in the present invention, information which is recorded on an under face of the first information recording medium like a passport whose end part is easily folded or the like and which is easily floated from the placement member, or information recorded on an under face of the first information recording medium which is easily floated from the placement member due to a booklet shape like a passport can be read optically and adequately.

Further, in the information reading device in accordance with the present invention, a distance in the right and left direction of the two pressing parts is wider than a width in the right and left direction of the second information recording medium. Further, the information reading device in at least an embodiment of the present invention includes a contact member having a contact part structured to contact with a rear end of the second information recording medium and, when the second information recording medium is inserted into the information reading device, a rear end of the second information recording medium contacts with the contact part. Therefore, when information recorded on an upper face of the second information recording medium is to be read optically, the second information recording medium can be positioned in the front and rear direction at a position where an image of the pressing member is not captured. Accordingly, in the present invention, information recorded on an upper face of the second information recording medium can be read optically. Further, the second information recording medium is hard to be floated from the placement member and thus, in the present invention, even when the second information recording medium is not pressed down from an upper side, information recorded on an under face of the second information recording medium can be read optically and adequately. Therefore, according to the present invention, information recorded on both faces of the second information recording medium like an ID card which is hard to be floated from the placement member and is smaller than the first information recording medium can be read optically and adequately.

In the present invention, when the first information recording medium is inserted into the information reading device, the contact part is moved upward to allow a rear end of the first information recording medium to pass through a lower side with respect to the contact part. Therefore, even when a width in the front and rear direction of a portion of the first information recording medium placed on the placement member is wider than a width in the front and rear direction of a portion of the second information recording medium placed on the placement member, the first information recording medium can be inserted to a predetermined position in the front and rear direction. Accordingly, in the present invention, information recorded on an under face of the first information recording medium can be read optically and adequately.

In passports of various countries in the world, passports prepared according to the guideline released by the International Civil Aviation Organization (ICAO) have increased. In the passports prepared according to the guideline, the face photograph, the name and the like are described on a rear face of a front cover of a passport placed on the placement member. Further, in this passport, characters utilized in character recognition are recorded on rear end portions of both end parts in the right and left direction of the rear face of the front cover. Therefore, in the case of this passport, when rear end portions of both end parts in the right and left direction of a front cover of a passport are folded or bent (curled), character recognition cannot be performed adequately. Especially, in a case that a face on which gloss processing is performed like a rear face of a front cover of a passport is to be read, when rear end portions of both end parts in the right and left direction of a passport are folded or the like, in comparison with another face or another information recording medium on which gloss processing is not performed, recorded information is hard to be read adequately due to an excessive light quantity or an insufficient light quantity.

Therefore, in the present invention, it is preferable that the pressing parts press down at least rear end portions of the both end parts in the right and left direction of the first information recording medium from the upper side. According to this structure, even in a case that a rear end portion of the first information recording medium is folded or the like, when information recorded on an under face of the first information recording medium is to be optically read, floating of an under face of the rear end portion of both end parts in the right and left direction of the first information recording medium from an upper face of the placement member can be suppressed. Therefore, even when the first information recording medium is, for example, an information recording medium in which characters for character recognition are recorded on rear end portions of both end parts in the right and left direction of the information recording medium like a passport prepared according to the guideline of the International Civil Aviation Organization, the characters recorded on the rear end portions of both end parts in the right and left direction of the first information recording medium can be adequately read to perform character recognition processing adequately.

In the present invention, it is preferable that, when the first information recording medium is inserted into the information reading device, the pressing parts are moved upward by the first information recording medium to press down at least the parts of the both end parts in the right and left direction of the first information recording medium from the upper side. According to this structure, the pressing parts can be moved upward by utilizing the first information recording medium inserted into the information reading device. Therefore, in comparison with a case that another mechanism for moving the pressing parts upward is separately provided, the structure of the information reading device can be simplified.

In the present invention, it is preferable that a lifted amount of the contact part when the first information recording medium has been inserted into the information reading device is larger than a lifted amount of the pressing part which is moved upward by the first information recording medium. According to this structure, even when a deformed amount of an end part of the first information recording medium is large, contact of a rear end of the first information recording medium inserted into the information reading device with the contact part can be prevented. Therefore, even when a deformed amount of an end part of the first information recording medium is large, a rear end of the first information recording medium can be inserted to a rear side with respect to the contact part.

In the present invention, it is preferable that, when the first information recording medium is inserted into the information reading device, the contact part is moved upward in cooperation with a lifted operation of the pressing part. In this case, for example, the pressing member and the contact member are separately provided from each other and, when the first information recording medium is inserted into the information reading device, the contact member is pushed to an upper side by the pressing member and the contact part is moved upward. According to this structure, the contact part can be moved upward by utilizing an operation of the pressing part which is moved upward by the first information recording medium. Therefore, in comparison with a case that a mechanism for moving the contact part upward is provided separately, a structure of the information reading device can be simplified.

In the present invention, the information reading device includes, for example, a holding member which holds the contact member so that the contact member is turnable with the right and left direction as an axial direction of turning, and one of the holding member and the pressing member is formed or fixed with a guide pin for guiding the pressing member in the upper and lower direction with respect to the holding member so that the guide pin is protruded in the right and left direction, and the other of the holding member and the pressing member is formed with a guide groove with which the guide pin is engaged.

In the present invention, it is preferable that the pressing member is turnable with respect to the holding member with the guide pin as a center and with the right and left direction as an axial direction of turning, the pressing member is formed with a pressing-up part structured to contact with the contact member from a lower side to push up the contact part and, when viewed in the right and left direction, the pressing-up part is disposed directly below the guide pin. In this case, for example, an upper face of the pressing-up part is formed to be a protruding curved face shape which is a circular arc shape when viewed in the right and left direction. According to this structure, even when the pressing member is turned and inclined with the guide pin as a center, a contact position of the pressing-up part and the contact member in the upper and lower direction is hard to vary. Therefore, even when the pressing member is turned and inclined with the guide pin as a center, variation of a lifted amount of the contact part can be suppressed.

In the present invention, it is preferable that the information reading device includes a cover member having a transparent upper face part which is disposed on an upper side with respect to the information recording medium placed on the placement member, and an urging member which urges the pressing member to a lower side with respect to the holding member. The holding member is contacted with an under face of the upper face part and, when the first information recording medium is not inserted into the information reading device, the pressing member is contacted with the upper face of the placement member. According to this structure, when the urging member is resiliently bent, the holding member, the contact member and the pressing member can be detached from the cover member and the placement member. In other words, according to this structure, the holding member, the contact member and the pressing member can be detachably attached to the cover member and the placement member. Therefore, when the holding member, the contact member and the pressing member are detached, an upper face of the placement member can be cleaned easily.

In the present invention, it is preferable that the information reading device includes a first compression coil spring as the urging member which is disposed on a front end side of the holding member, and a second compression coil spring as the urging member which is disposed on a rear end side of the holding member. The pressing member is formed with a pressing-up part structured to contact with the contact member from the lower side to push the contact part upward, the pressing-up part is disposed on a rear side with respect to the contact part, a turning center of the contact member with respect to the holding member is disposed on a rear side with respect to the pressing-up part, and an urging force of the first compression coil spring is stronger than an urging force of the second compression coil spring. According to this structure, after the first information recording medium is begun to be inserted into the information reading device, at an earlier stage, the pressing-up part can be moved upward, and as a result, after the first information recording medium is begun to be inserted into the information reading device, at an earlier stage, the contact part can be pushed upward by the pressing-up member part. Therefore, contact of a rear end of the first information recording medium inserted into the information reading device with the contact part is easily prevented further surely.

In the present invention, it is preferable that the pressing member includes the two pressing parts which are formed in a straight shape parallel to the front and rear direction and a connection part which connects rear end parts of the two pressing parts, and an upper side of the pressing part is a light passage part through which light emitted from the second illumination part is passed. According to this structure, even when the pressing member for pressing down both end parts in the right and left direction of the first information recording medium is provided, an upper face of the information recording medium placed on the placement member can be irradiated with light adequately.

In the present invention, it is preferable that an upper face of the pressing part is formed to be an inclined face which is inclined to a lower side as going to an inner side in the right and left direction. According to this structure, light emitted from the second illumination part is hard to be blocked by the pressing part. Further, according to this structure, the second information recording medium inserted into the information reading device can be guided by utilizing the inclined face between the two pressing parts.

In the present invention, it is preferable that a center portion in the right and left direction of an under face of the contact part is formed with a recessed part which is recessed to an upper side, and a width in the right and left direction of the recessed part is set to be narrower than the width in the right and left direction of the second information recording medium. In this case, for example, the recessed part is formed in a recessing curved face shape which is a circular arc shape when viewed in the front and rear direction. According to this structure, even when a center part in the right and left direction of a rear end part of the first information recording medium whose both end parts in the right and left direction are pressed down by the pressing parts is deformed largely, contact of a rear end of the first information recording medium inserted into the information reading device with the contact part can be prevented. Therefore, even when a center part in the right and left direction of a rear end part of the first information recording medium whose both end parts in the right and left direction are pressed down is deformed largely, a rear end of the first information recording medium can be inserted to a rear side with respect to the contact part.

As described above, according to at least an embodiment of the present invention, in an information reading device structured to optically read information recorded on an information recording medium, information recorded on an under face of a first information recording medium, which is easily floated from the placement member like a passport, and informations recorded on both sides of a second information recording medium like an ID card which is hard to be floated from the placement member and is smaller than the first information recording medium can be optically and adequately read.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing an information reading device in accordance with an embodiment of the present invention.

FIG. 2 is a perspective view showing a placement member, a cover member, a first illumination part, a second illumination part and a medium pressing mechanism of the information reading device shown in FIG. 1.

FIG. 3A and FIG. 3B are front views showing the placement member, the cover member, the first illumination part, the second illumination part and the medium pressing mechanism shown in FIG. 2.

FIG. 4 is an explanatory side view showing optical paths in an inside of the information reading device shown in FIG. 1.

FIG. 5A and FIG. 5B are explanatory side views showing an operation of a shutter mechanism of the information reading device shown in FIG. 1.

FIG. 6 is a perspective view showing the medium pressing mechanism in FIG. 2 which is viewed from another direction.

FIG. 7 is a front view showing the medium pressing mechanism in FIG. 2.

FIG. 8 is an exploded perspective view showing the medium pressing mechanism in FIG. 2.

FIG. 9A and FIG. 9B are explanatory perspective views showing states that an information recording medium is inserted into the information reading device shown in FIG. 1.

FIG. 10A and FIG. 10B are explanatory side views showing an operation of a pressing member and a contact member when a first information recording medium has been inserted into the information reading device shown in FIG. 1.

FIG. 11A and FIG. 11B are explanatory side views showing a positional relationship between a pressing-up part and a guide pin shown in FIG. 6.

### DETAILED DESCRIPTION

An embodiment of the present invention will be described below with reference to the accompanying drawings.

### Schematic Structure of Information Reading Device

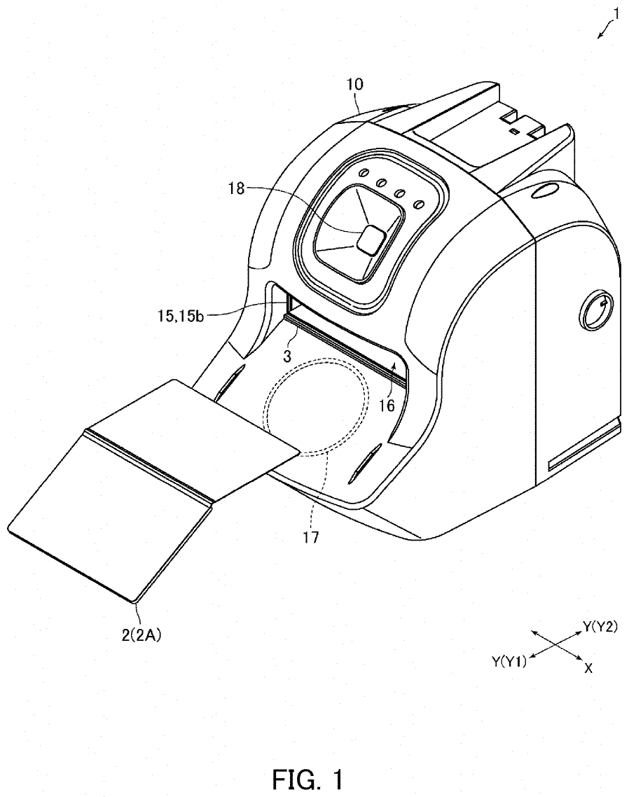

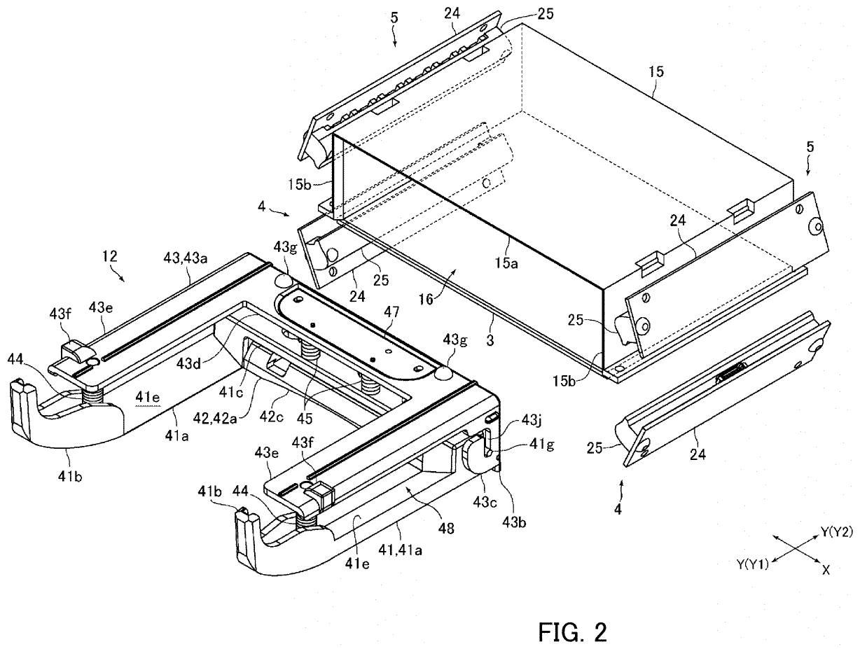

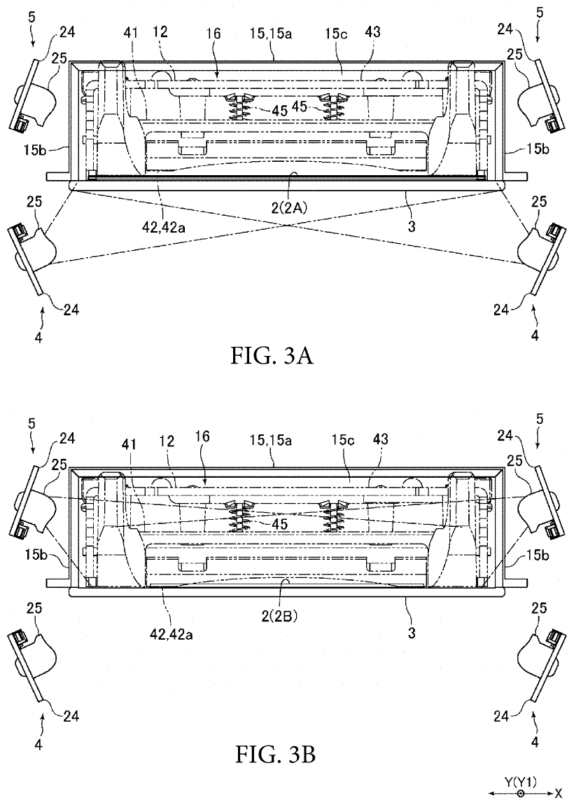

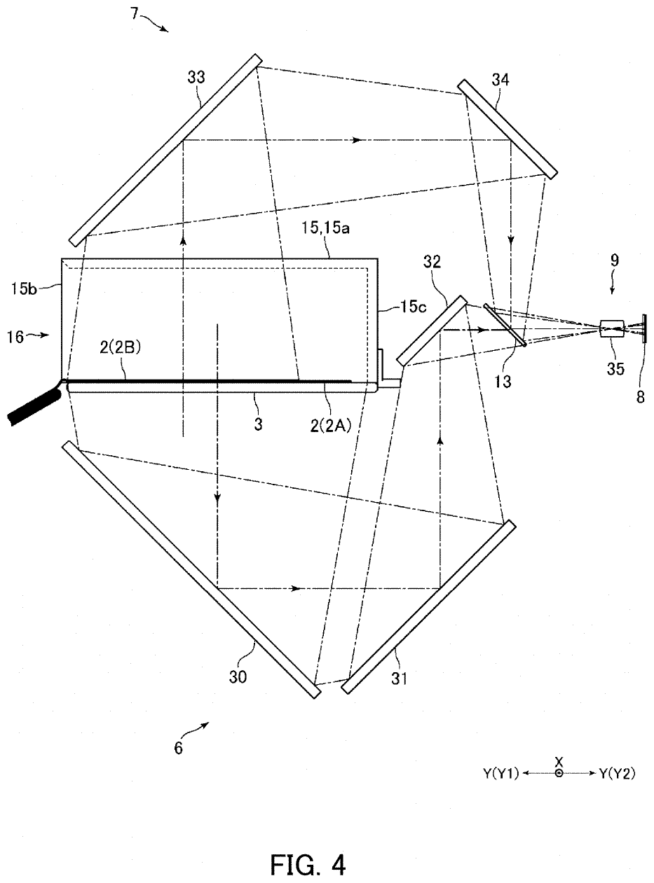

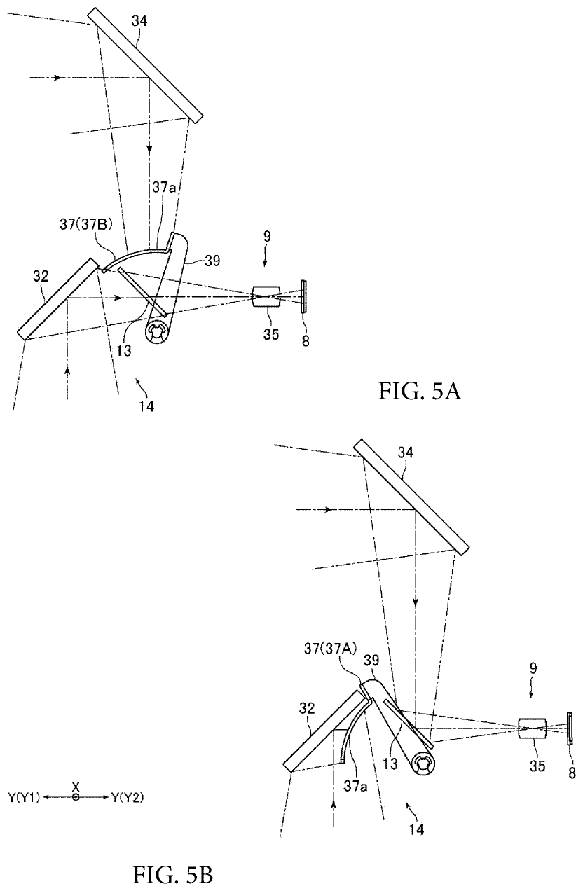

FIG. 1 is a perspective view showing an information reading device 1 in accordance with an embodiment of the present invention. FIG. 2 is a perspective view showing a glass plate 3, a cover member 15, illumination parts 4 and 5, and a medium pressing mechanism 12 of the information reading device 1 shown in FIG. 1. FIG. 3A and FIG. 3B are front views showing the glass plate 3, the cover member 15, the illumination parts 4 and 5, and the medium pressing mechanism 12 shown in FIG. 2. FIG. 4 is an explanatory side view showing optical paths in an inside of the information reading device 1 shown in FIG. 1. FIG. 5A and FIG. 5B are explanatory side views showing an operation of a shutter mechanism 14 of the information reading device 1 shown in FIG. 1.

An information reading device 1 in this embodiment is a device structured to optically read information recorded on an information recording medium 2. In other words, the information reading device 1 is a device structured to read characters or a graphic which are printed or the like on an information recording medium 2. The information reading device 1 is a manual type reading device, and insertion of an information recording medium 2 to the information reading device 1 and taking-out of the information recording medium 2 from the information reading device 1 are manually performed. Further, the information reading device 1 in this embodiment is a comparatively small table top type reading device. An information recording medium 2 which is read by the information reading device 1 is a passport 2A and an ID card 2B (see FIG. 3A and FIG. 3B).

In a case that an information recording medium 2 is a passport 2A, information recorded on a rear face of a front cover of the passport 2A is optically read by the information reading device 1. In a case that an information recording medium 2 is an ID card 2B, informations recorded on both faces of the ID card 2B are optically read by the information reading device 1. A passport 2A in this embodiment is an IC passport, which includes an IC page in which an IC chip and an antenna for communication are incorporated. Further, an ID card 2B is a non-contact type IC card, and an IC chip and an antenna for communication is incorporated in the ID card 2B. The ID card 2B is formed in a rectangular shape. Further, the ID card 2B is, for example, a rectangular card made of vinyl chloride whose thickness is about 0.7-0.8 mm.

The passport 2A is inserted into the information reading device 1 in an opened state. A thickness direction of a front cover in an opened state of the passport 2A which has been inserted into the information reading device 1 is coincided with an upper and lower direction. Further, a thickness direction of an ID card 2B having been inserted into the information reading device 1 is coincided with the upper and lower direction. The passport 2A in this embodiment is a first information recording medium and the ID card 2B is a second information recording medium. In FIG. 4, for convenience of explanation, both of the passport 2A and the ID card 2B have been inserted into the information reading device 1. However, actually, one of the passport 2A and the ID card 2B is inserted into the information reading device 1.

In the following descriptions, an inserting direction side of an information recording medium 2 to the information reading device 1 (“Y2” direction side in FIG. 1 and the like) is referred to as a “back” side or a “rear” side, and a taking-out direction side of the information recording medium 2 from the information reading device 1 is referred to as a “front” side (“Y1” direction side in FIG. 1 and the like). Further, an insertion taking-out direction of an information recording medium 2 for the information reading device 1 is referred to as a “front and rear direction” (“Y” direction in FIG. 1 and the like), and a direction perpendicular to the upper and lower direction and the front and rear direction is referred to as a “right and left direction” (“X” direction in FIG. 1 and the like).

The information reading device 1 includes a transparent glass plate 3 on which an information recording medium 2 is placed, an illumination part 4 structured to irradiate an under face of the information recording medium 2 placed on the glass plate 3 with light, an illumination part 5 structured to irradiate an upper face of the information recording medium 2 placed on the glass plate 3 with light, an optical system 6 structured to read information recorded on the under face of the information recording medium 2 placed on the glass plate 3, an optical system 7 structured to read information recorded on the upper face of the information recording medium 2 placed on the glass plate 3, an image pickup element 8, an image-forming optical system 9 which forms an image of the light passed through the optical system 6 on the image pickup element 8 and forms an image of the light passed through the optical system 7 on the image pickup element 8, and a housing 10 which accommodates these structures. The image pickup element 8 is a two-dimensional CMOS image sensor or CCD image sensor. The glass plate 3 in this embodiment is a placement member, the illumination part 4 is a first illumination part and the illumination part 5 is a second illumination part. Further, the optical system 6 is a first optical system and the optical system 7 is a second optical system.

Further, the information reading device 1 includes a medium pressing mechanism 12 structured to press both end parts in the right and left direction of the passport 2A placed on the glass plate 3 from an upper side. Further, the information reading device 1 includes a beam splitter 13, which transmits a part of the light passed through the optical system 6 toward the image-forming optical system 9 and reflects a part of the light passed through the optical system 7 toward the image-forming optical system 9, and a shutter mechanism 14 structured to block the light made incident to the beam splitter 13 from the optical system 7 when information recorded on the under face of the information recording medium 2 placed on the glass plate 3 is to be read, and to block the light made incident to the beam splitter 13 from the optical system 6 when information recorded on the upper face of the information recording medium 2 placed on the glass plate 3 is to be read. The beam splitter 13 and the shutter mechanism 14 are accommodated in the housing 10. In FIG. 4, the medium pressing mechanism 12 is not shown.

In addition, the information reading device 1 includes a cover member 15 which is provided with an upper face part 15a disposed on an upper side with respect to the information recording medium 2 placed on the glass plate 3, two side face parts 15b connected with both end sides in the right and left direction of the upper face part 15a, and a rear face part 15c connected with a rear end side of the upper face part 15a. The cover member 15 in this embodiment is structured of the upper face part 15a, two side face parts 15b and the rear face part 15c. The cover member 15 is formed of transparent resin such as acrylic resin. The rear face part 15c is coated with, for example, a light shielding coating material and the rear face part 15c is formed to be a light shielding part which blocks the light directing to the rear side. On the other hand, the upper face part 15a and the side face parts 15b are transparent.

The upper face part 15a is formed in a rectangular flat plate shape and is disposed so that a thickness direction of the upper face part 15a and the upper and lower direction are coincided with each other. Further, the upper face part 15a is disposed so that end faces of the upper face part 15a are parallel to the front and rear direction or the right and left direction. The side face part 15b is formed in a rectangular flat plate shape and is disposed so that a thickness direction of the side face part 15b and the right and left direction are coincided with each other. The rear face part 15c is formed in a rectangular flat plate shape and is disposed so that a thickness direction of the rear face part 15c and the front and rear direction are coincided with each other. Both right and left ends of the rear face part 15c are connected with the rear ends of the side face parts 15b.

The glass plate 3 is formed in a rectangular flat plate shape and is disposed so that a thickness direction of the glass plate 3 and the upper and lower direction are coincided with each other. Further, the glass plate 3 is disposed so that end faces of the glass plate 3 are parallel to the front and rear direction or the right and left direction. Lower ends of the side face parts 15b and a lower end of the rear face part 15c are contacted with an upper face of the glass plate 3. In this embodiment, a box-shaped medium arrangement part 16 is formed by the glass plate 3 and the cover member 15 so that its front face is opened and in which at least a part of the information recording medium 2 is disposed. The medium arrangement part 16 is formed in a rectangular parallelepiped box shape. As shown in FIG. 1, a portion of the medium arrangement part 16 except the opening of the front face is covered by the housing 10.

The whole of an ID card 2B is placed on the glass plate 3. Further, a part of the passport 2A is placed on the glass plate 3 so that a back cover of the passport 2A in an opened state is disposed on a front end side of the glass plate 3. The passport 2A is placed on the glass plate 3 so that a rear face of the front cover where personal information is recorded faces a lower side. In this embodiment, a width in the front and rear direction of a portion of the passport 2A which is placed on the glass plate 3 is wider than a width in the front and rear direction of the ID card 2B placed on the glass plate 3 (in other words, a width in the front and rear direction of a portion of the ID card 2B which is placed on the glass plate 3). Further, a width in the right and left direction of the passport 2A is wider than a width in the right and left direction of the ID card 2B placed on the glass plate 3.

The passport 2A in this embodiment is a passport prepared according to the guideline released by the International Civil Aviation Organization (ICAO). A rear face of the front cover of the passport 2A placed on the glass plate 3 is described with a face photograph, a name and the like. Further, characters used in character recognition are recorded in rear end portions of both end parts in the right and left direction of the rear face of the front cover of the passport 2A.

An antenna (not shown) for communicating with a communication antenna incorporated in the ID card 2B is disposed on a lower side with respect to the glass plate 3. The antenna is disposed at a position without a hindrance when information of an under face of the information recording medium 2 placed on the glass plate 3 is to be optically read. Further, as shown in FIG. 1, an antenna 17 for communicating with a communication antenna incorporated in the passport 2A is disposed on a front side with respect to the glass plate 3. The antenna 17 is disposed on a lower side with respect to the glass plate 3. In this embodiment, communication may be performed between the antenna disposed on a lower side with respect to the glass plate 3 and the antenna incorporated in the passport 2A depending on the specifications of the passport 2A.

The information reading device 1 includes, as shown in FIG. 1, a camera 18 disposed on the front face side and the upper face side of the information reading device 1. The camera 18 is disposed on the upper side with respect to the medium arrangement part 16. An optical axis of the camera 18 is inclined toward the upper side as going to the front side. The camera 18 photographs, for example, a face of a person performing a reading operation of an information recording medium 2.

### Structure and Arrangement of Illumination Part

Each of the illumination parts 4 and 5 includes a circuit board 24 on which a plurality of light sources is mounted and an illumination lens 25 to which lights emitted from the light sources are made incident. Each of the illumination parts 4 and 5 in this embodiment includes as the light sources, a plurality of white LEDs which emit white light, a plurality of infrared LEDs which emit infrared light, and a plurality of ultraviolet LEDs which emit ultraviolet light. The circuit board 24 is formed in a long and thin rectangular flat plate shape. The illumination lens 25 is formed in a long and slender roughly rectangular solid shape. The illumination lens 25 is fixed to a face of the circuit board 24 on which the light sources are mounted.

The white light emitted from the white LED, the infrared light emitted from the infrared LED and the ultraviolet light emitted from the ultraviolet LED are made incident to the illumination lens 25. The light transmitted through the illumination lens 25 is irradiated on the information recording medium 2. In this embodiment, the infrared lights emitted from the illumination parts 4 and 5 are used for reading mechanical reading type printed information such as OCR characters. Further, the ultraviolet lights emitted from the illumination parts 4 and 5 are used for reading printed information required to determine authenticity of an information recording medium 2. Specifically, the ultraviolet lights emitted from the illumination parts 4 and 5 are used for reading information printed by invisible fluorescent color developing ink.

As shown in FIG. 3A and FIG. 3B, the illumination parts 4 are disposed on a lower side with respect to the glass plate 3. Further, the information reading device 1 includes two illumination parts 4, and the illumination parts 4 are disposed on respective outer sides in the right and left direction with respect to the glass plate 3. The illumination parts 4 irradiate an information recording medium 2 placed on the glass plate 3 with lights from outer sides in the right and left direction and from obliquely lower sides. Further, as shown in FIG. 3A, the lights emitted from the illumination parts 4 and transmitted through the glass plate 3 are irradiated on an under face of the information recording medium 2 placed on the glass plate 3.

The illumination parts 5 are disposed on an upper side with respect to the information recording medium 2 placed on the glass plate 3. Further, the information reading device 1 includes two illumination parts 5, and the illumination parts 5 are disposed on respective outer sides in the right and left direction with respect to the medium arrangement part 16. In other words, one of the two illumination parts 5 is disposed on the right side with respect to the side face part 15b disposed on the right side, and the other of the two illumination parts 5 is disposed on the left side with respect to the side face part 15b disposed on the left side. The illumination parts 5 irradiate the information recording medium 2 placed on the glass plate 3 with lights from outer sides in the right and left direction and from obliquely upper sides. Further, as shown in FIG. 3B, the lights emitted from the illumination parts 5 and transmitted through the side face parts 15b are irradiated on an upper face of the information recording medium 2 placed on the glass plate 3.

### Structure and Arrangement of Optical System, Image-forming Optical System, Beam Splitter and Image Pickup Element

The optical system 6 includes three reflection mirrors (total reflection mirror) 30, 31 and 32 which are formed in a rectangular flat plate shape. The reflection mirrors 30 and 31 are disposed on a lower side with respect to the glass plate 3. Specifically, the reflection mirror 30 is disposed on a lower side with respect to the passport 2A placed on the glass plate 3. Further, the reflection mirror 31 is disposed at substantially the same height as the reflection mirror 30 and is disposed on a rear side with respect to the reflection mirror 30. The reflection mirror 32 is disposed on a rear side with respect to the medium arrangement part 16 (rear side with respect to the rear face part 15c of the cover member 15). Further, the reflection mirror 32 is disposed on an upper side with respect to the reflection mirror 31.

The reflection mirrors 30 through 32 are disposed in an inclined state by a predetermined angle with respect to the upper and lower direction. The reflection mirror 30 is inclined toward the lower side as going to the rear side, and the reflection mirrors 31 and 32 are inclined toward the upper side as going to the rear side. Inclination angles of the reflection mirrors 30 through 32 with respect to the upper and lower direction are set at substantially 45°. A light reflected by an under face of the information recording medium 2 placed on the glass plate 3 is made incident on the reflection mirror 30. The light reflected by the reflection mirror 30 is made incident on the reflection mirror 31, and the light reflected by the reflection mirror 31 is made incident on the reflection mirror 32.

The optical system 7 includes two reflection mirrors (total reflection mirror) 33 and 34 which are formed in a rectangular flat plate shape. The reflection mirrors 33 and 34 are disposed on an upper side with respect to the information recording medium 2 placed on the glass plate 3. Specifically, the reflection mirror 33 is disposed on an upper side with respect to an ID card 2B placed on the glass plate 3. Further, the reflection mirror 33 is disposed on an upper side with respect to the upper face part 15a of the cover member 15 (upper side with respect to the medium arrangement part 16). The reflection mirror 34 is disposed at substantially the same height as the reflection mirror 33 and is disposed on a rear side with respect to the glass plate 3 (in other words, rear side with respect to the medium arrangement part 16).

Each of the reflection mirrors 33 and 34 is disposed in an inclined state by a predetermined angle with respect to the upper and lower direction. The reflection mirror 33 is inclined toward an upper side as going to the rear side, and the reflection mirror 34 is inclined toward the lower side as going to the rear side. Inclination angles of the reflection mirrors 33 and 34 with respect to the upper and lower direction are set at substantially 45°. The light reflected by an upper face of the information recording medium 2 placed on the glass plate 3 is made incident on the reflection mirror 33. The light reflected by the reflection mirror 33 is made incident on the reflection mirror 34.

The image-forming optical system 9 includes an image-forming lens 35. The image-forming lens 35 is disposed on a rear side with respect to the reflection mirror 32. Further, the image-forming lens 35 is disposed on a rear side with respect to the reflection mirror 34. The image pickup element 8 is disposed on a rear side with respect to the image-forming lens 35. In other words, the image pickup element 8 is disposed on a rear side with respect to the rear face part 15c. The image pickup element 8 is disposed so that an imaging surface of the image pickup element 8 faces the front side.

The beam splitter 13 is formed in a rectangular flat plate shape. The beam splitter 13 in this embodiment is a half mirror whose transmittance and reflectance of light are equal to each other. The beam splitter 13 is disposed between the reflection mirror 32 and the image-forming lens 35 in the front and rear direction. In other words, the beam splitter 13 is disposed on the rear side with respect to the reflection mirror 32 and on the front side with respect to the image-forming lens 35. Further, the beam splitter 13 is disposed on the lower side with respect to the reflection mirror 34.

The beam splitter 13 is disposed in an inclined state by a predetermined angle with respect to the upper and lower direction. Specifically, the beam splitter 13 is inclined toward the lower side as going to the rear side. An inclination angle of the beam splitter 13 with respect to the upper and lower direction is set at substantially 45°. The beam splitter 13 transmits a half of the light reflected by the reflection mirror 32 toward image-forming lens 35 and reflects a half of the light reflected by the reflection mirror 34 toward the image-forming lens 35.

### Structure of Shutter Mechanism

The shutter mechanism 14 includes a shutter 37 which is movable between a first light shielding position 37A (see FIG. 5B) where a light path between the optical system 6 and the beam splitter 13 (in other words, a light path between the reflection mirror 32 and the beam splitter 13) is blocked, and a second light shielding position 37B (see FIG. 5A) where a light path between the optical system 7 and the beam splitter 13 (in other words, a light path between the reflection mirror 34 and the beam splitter 13) is blocked. The shutter 37 is provided with a light shielding part 37a which blocks either of the light paths between the reflection mirrors 32 and 34 and the beam splitter 13.

The shutter mechanism 14 includes a shutter drive mechanism structured to move the shutter 37 between the first light shielding position 37A and the second light shielding position 37B. The shutter drive mechanism includes a lever member 39 to which the shutter 37 is fixed, a solenoid (not shown) for turning the lever member 39, and the like. The lever member 39 is turnable with the right and left direction as an axial direction of turning.

### Structure of Medium Pressing Mechanism

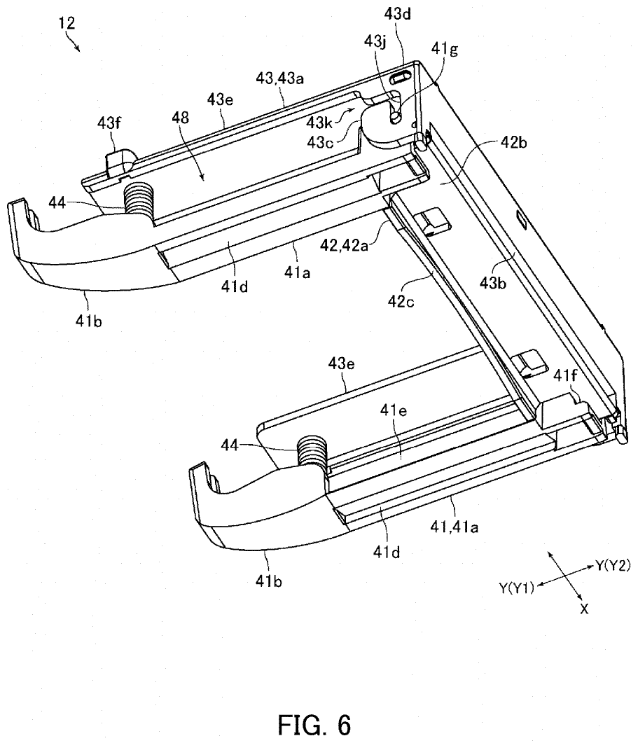

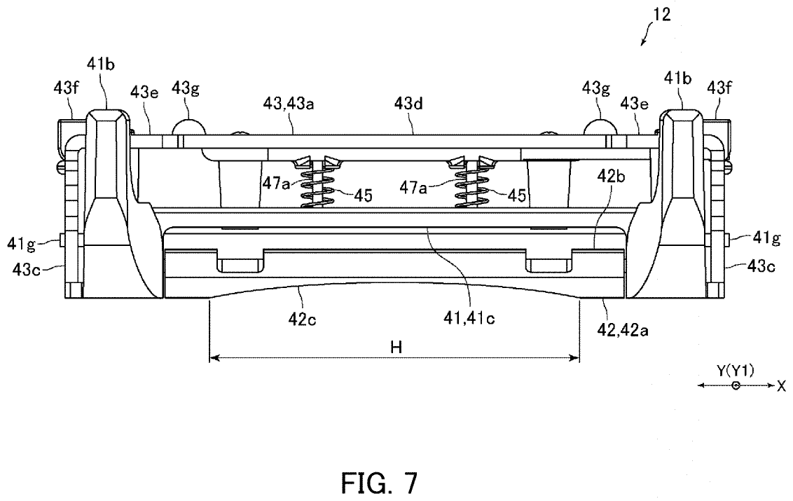

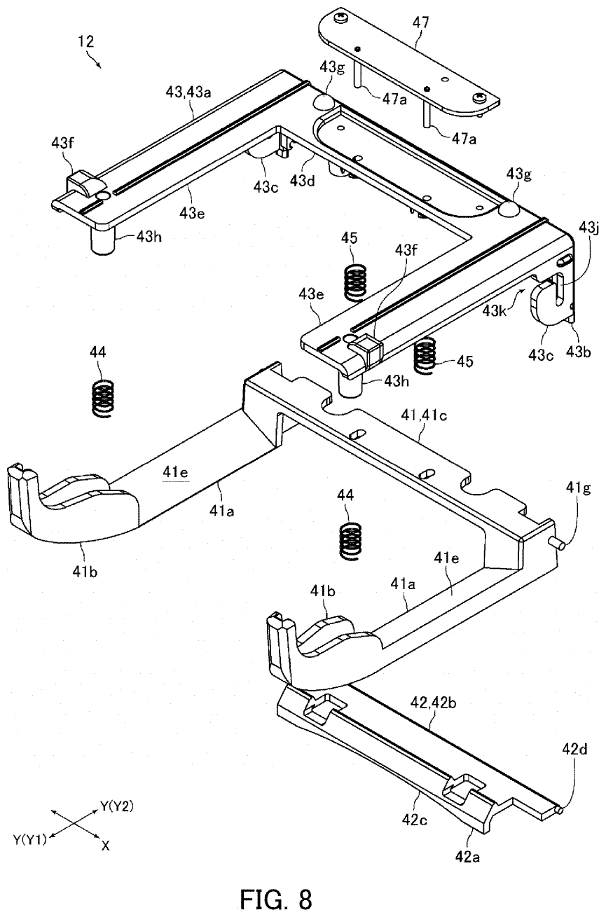

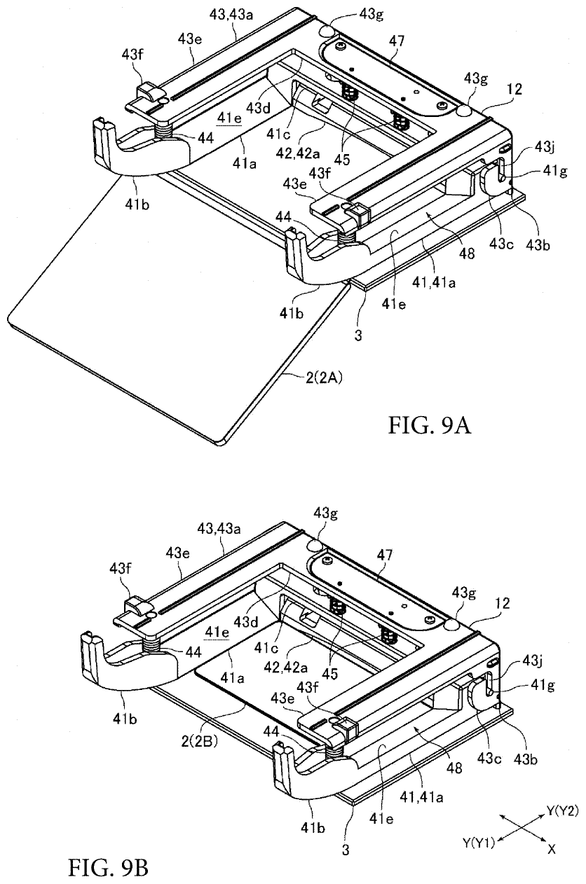

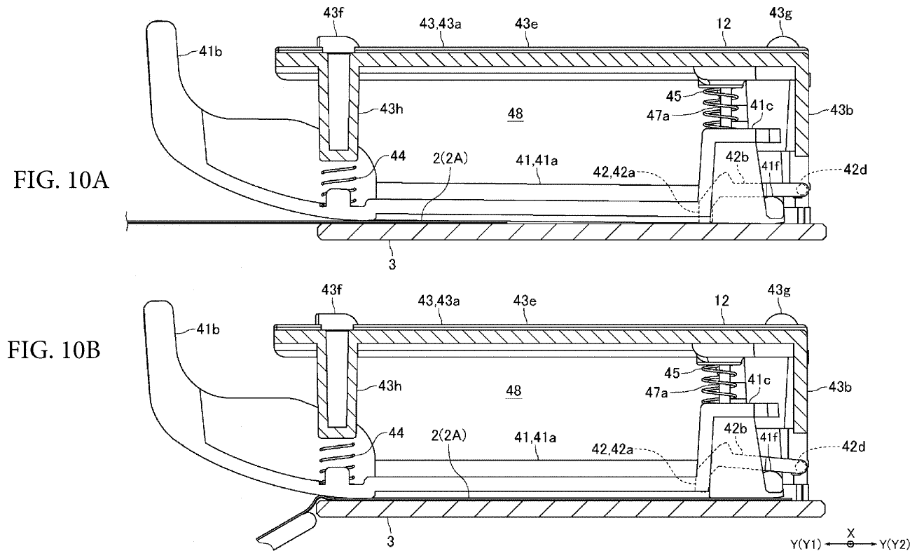

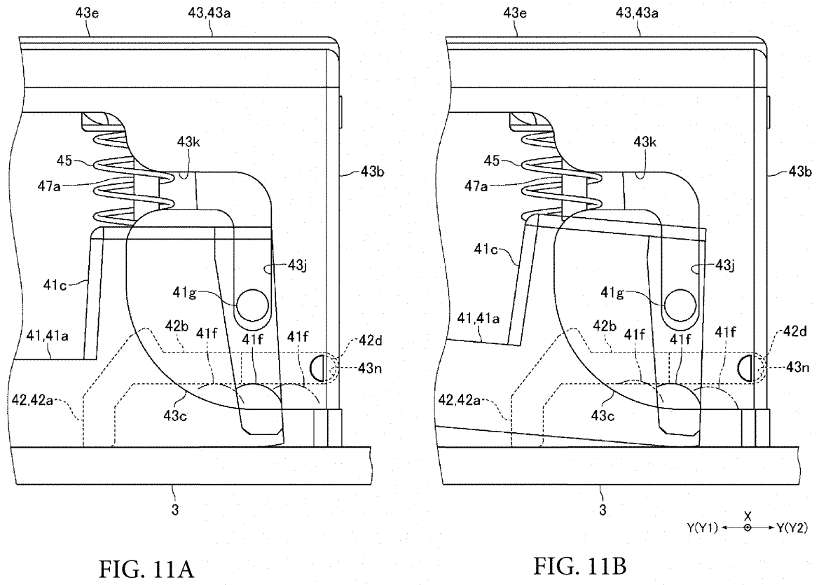

FIG. 6 is a perspective view showing the medium pressing mechanism 12 in FIG. 2 which is viewed from another direction. FIG. 7 is a front view showing the medium pressing mechanism 12 in FIG. 2. FIG. 8 is an exploded perspective view showing the medium pressing mechanism 12 in FIG. 2. FIG. 9A and FIG. 9B are explanatory perspective views showing states that an information recording medium 2 is inserted into the information reading device 1 shown in FIG. 1. FIG. 10A and FIG. 10B are explanatory side views showing an operation of a pressing member 41 and a contact member 42 when a passport 2A has been inserted into the information reading device 1 shown in FIG. 1. FIG. 11A and FIG. 11B are explanatory side views showing a positional relationship between a pressing-up part 41f and a guide pin 41g shown in FIG. 6.

The medium pressing mechanism 12 is disposed in an inside of the medium arrangement part 16. The medium pressing mechanism 12 includes the pressing member 41 having two pressing parts 41a structured to press down both end parts in the right and left direction of a passport 2A from an upper side, the contact member 42 having a contact part 42a structured to contact with a rear end (back end) of an ID card 2B, and a holding member 43 which holds the pressing member 41 and the contact member 42. Further, the medium pressing mechanism 12 includes compression coil springs 44 and 45 as an urging member which urge the pressing member 41 to the lower side with respect to the holding member 43. The medium pressing mechanism 12 in this embodiment includes two compression coil springs 44 and two compression coil springs 45, i.e., totaled four compression coil springs 44 and 45.

The holding member 43 is formed of resin. The holding member 43 is provided with an upper face part 43a structuring an upper face of the medium pressing mechanism 12, a rear face part 43b structuring a rear face of the medium pressing mechanism 12, and side face parts 43c structuring right and left side faces on the rear end side of the medium pressing mechanism 12. The upper face part 43a is structured of a base part 43d which is formed in a substantially rectangular flat plate shape whose length in the right and left direction is long, and two protruded parts 43e which are protruded toward the front side from both end sides in the right and left direction of the base part 43d. The base part 43d is disposed so that a thickness direction of the base part 43d and the upper and lower direction are coincided with each other. The protruded part 43e is formed in a substantially rectangular flat plate shape whose length in the front and rear direction is long and is disposed so that a thickness direction of the protruded part 43e and the upper and lower direction are coincided with each other.

The rear face part 43b is formed in a substantially rectangular flat plate shape whose length in the right and left direction is long and is disposed so that a thickness direction of the rear face part 43b and the front and rear direction are coincided with each other. An upper end of the rear face part 43b is connected with a rear end of the base part 43d. The side face part 43c is formed in a substantially rectangular flat plate shape and is disposed so that a thickness direction of the side face part 43c and the right and left direction are coincided with each other. The upper ends of the side face parts 43c are respectively connected with both ends in the right and left direction of the base part 43d, and the rear ends of the side face parts 43c are respectively connected with both ends in the right and left direction of the rear face part 43b.

An upper face of the upper face part 43a is formed with two protruded parts 43f and two protruded parts 43g which are protruded toward the upper side. The protruded parts 43f are formed in respective front end side portions of two protruded parts 43e. The protruded parts 43g are formed on respective both end sides in the right and left direction of the base part 43d. An upper face of the protruded part 43f is formed to be a flat face perpendicular to the upper and lower direction. The protruded part 43g is formed in a hemispherical shape. Upper faces of the protruded parts 43f and upper ends of the protruded parts 43g are contacted with an under face of the upper face part 15a of the cover member 15. In other words, the holding member 43 is contacted with the under face of the upper face part 15a.

A columnar spring holding part 43h is formed on a front end side of the protruded part 43e so as to be protruded toward the lower side. The spring holding part 43h is inserted into an inner peripheral side of the compression coil spring 44. The base part 43d is fixed with a spring holding member 47 which is formed with a shaft part 47a inserted into an inner peripheral side of the compression coil spring 45. The spring holding member 47 is fixed to an upper face side of the base part 43d so that the shaft parts 47a are protruded to a lower side from the base part 43d. The spring holding member 47 is formed with two shaft parts 47a.

The side face part 43c is formed with a guide groove 43j structured to guide the pressing member 41 in the upper and lower direction with respect to the holding member 43. The guide groove 43j is penetrated through the side face part 43c in the right and left direction and is formed in an elongated hole shape whose longitudinal direction is the upper and lower direction. Further, the side face part 43c is formed with a cut-out part 43k for fitting a guide pin 41g formed in the pressing member 41 described below to the guide groove 43j. The cut-out part 43k is formed between an upper end part of the guide groove 43j and a front end face of the side face part 43c.

Further, the side face part 43c is formed with a recessed part 43n which holds a pin 42d formed in the contact member 42 described below (see FIG. 11A and FIG. 11B). The recessed part 43n is formed so as to be recessed from an inner side face of the side face part 43c in the right and left direction toward an outer side in the right and left direction. A shape of the recessed part 43n is circular when viewed in the right and left direction. The recessed part 43n is disposed on a rear side with respect to the guide groove 43j. Further, the recessed part 43n is disposed on a lower side with respect to a lower end of the guide groove 43j.

The pressing member 41 is formed of resin. The pressing member 41 is, as described above, provided with two pressing parts 41a. The pressing part 41a is formed in a straight shape whose length in the front and rear direction is long. In other words, the pressing part 41a is formed in a straight shape which is parallel to the front and rear direction. Specifically, the pressing part 41a is formed in a plate shape whose length in the front and rear direction is long. Further, the pressing member 41 is provided with guide parts 41b which are respectively connected with front ends of two pressing parts 41a and a connection part 41c which connects rear end parts (back end parts) of the two pressing parts 41a. The connection part 41c connects upper sides of the rear end parts of the pressing parts 41a with each other.

An under face of the pressing part 41a is formed to be a flat face which is perpendicular to the upper and lower direction. However, the under face of the pressing part 41a is formed with a thickness reduced part 41d which is recessed to an upper side (see FIG. 6). An upper face 41e of the pressing part 41a is formed to be an inclined face which is inclined to a lower side as going to an inner side in the right and left direction. In other words, the upper face 41e of the pressing part 41a disposed on the right side is formed to be an inclined face which is inclined to a lower side as going to the left side, and the upper face 41e of the pressing part 41a disposed on the left side is formed to be an inclined face which is inclined to a lower side as going to the right side.

The pressing parts 41a provide a function that the pressing parts 41a are respectively contacted with at least parts of both end parts in the right and left direction of a passport 2A placed on the glass plate 3 (specifically, both end parts in the right and left direction of a front cover of a passport 2A) from an upper side to press down at least parts of the both end parts in the right and left direction of the passport 2A from the upper side. The pressing parts 41a in this embodiment are contacted with substantially the entire both end parts in the right and left direction of the passport 2A placed on the glass plate 3 (both end parts in the right and left direction of a front cover of the passport 2A) from an upper side to press down substantially the entire both end parts in the right and left direction of the passport 2A from the upper side. In other words, the pressing parts 41a in this embodiment are also contacted with rear end portions of both end parts in the right and left direction of the passport 2A from the upper side to press down also the rear end portions of the both end parts in the right and left direction of the passport 2A from the upper side.

Therefore, a distance in the right and left direction of the two pressing parts 41a is set to be smaller than a width in the right and left direction of the passport 2A (see FIG. 9A). On the other hand, a distance in the right and left direction of the two pressing parts 41a is set to be wider than a width in the right and left direction of an ID card 2B (see FIG. 3B and FIG. 9B). In other words, a width in the right and left direction of an ID card 2B placed on the glass plate 3 is smaller than the distance in the right and left direction of the two pressing parts 41a.

A rear end part of the pressing part 41a is formed with a pressing-up part 41f which is contacted with the contact member 42 from a lower side to push up the contact part 42a. In other words, the pressing-up part 41f is formed in each of the both end sides in the right and left direction of the pressing member 41. Further, the pressing-up part 41f is formed in a rear end part of the pressing member 41. The pressing-up part 41f is disposed on a lower side with respect to the connection part 41c. An upper face of the pressing-up part 41f is formed in a protruding curved face shape which is a circular arc shape when viewed in the right and left direction.

A width in the right and left direction of the guide part 41b is equal to a width in the right and left direction of the pressing part 41a. An under face of the guide part 41b is formed in a protruding curved face shape which is a circular arc shape when viewed in the right and left direction. Further, an under face of the guide part 41b is inclined toward an upper side as going to a front side. An inner side face in the right and left direction of the guide part 41b is formed in a recessing curved face shape which is a circular arc shape when viewed in the upper and lower direction. Further, the inner side faces in the right and left direction of the guide parts 41b are widened to an outer side in the right and left direction as going to a front side. The guide part 41b functions to guide a passport 2A inserted into the information reading device 1 to a lower side of the pressing part 41a. Further, the guide part 41b functions to guide an ID card 2B inserted into the information reading device 1 between the two pressing parts 41a.

The rear end part of the guide part 41b and the pressing part 41a are disposed on a lower side with respect to the protruded part 43e of the holding member 43. The connection part 41c is disposed on a lower side with respect to the base part 43d of the holding member 43. A lower end of the compression coil spring 44 is contacted with an upper face of the rear end part of the guide part 41b, and a lower end of the compression coil spring 45 is contacted with an upper face of the connection part 41c. In other words, the pressing member 41 is urged to the lower side with respect to the holding member 43 by the compression coil springs 44 and 45 and is movable in the upper and lower direction with respect to the holding member 43. When a passport 2A is not inserted into the information reading device 1, an under face of the pressing part 41a is contacted with an upper face of the glass plate 3 by the urging forces of the compression coil springs 44 and 45. In other words, when a passport 2A is not inserted into the information reading device 1, the pressing member 41 is contacted with the upper face of the glass plate 3.

Each of both side faces in the right and left direction of the connection part 41c is formed with the guide pin 41g which is protruded to an outer side in the right and left direction. The guide pin 41g is formed in a columnar shape. The guide pin 41g is disposed on an outer side in the right and left direction with respect to the pressing-up part 41f. Further, when viewed in the right and left direction, the guide pin 41g is, as shown by the solid line in FIG. 11A and FIG. 11B, disposed directly above the pressing-up part 41f. In other words, when viewed in the right and left direction, the pressing-up part 41f is disposed directly below the guide pin 41g.

The guide pin 41g is engaged with the guide groove 43j of the holding member 43. Specifically, each of the two guide pins 41g is engaged with each of the two guide grooves 43j from an inner side in the right and left direction. The pressing member 41 is guided in the upper and lower direction with respect to the holding member 43 by the guide pins 41g and the guide grooves 43j. Further, the pressing member 41 is turnable with respect to the holding member 43 with the guide pin 41g as a turning center and the right and left direction as an axial direction of turning.

A space is formed between the pressing part 41a and the protruded part 43e in the upper and lower direction. The space between the pressing part 41a and the protruded part 43e in the upper and lower direction is a light passage part 48 where a light emitted from the illumination part 5 is passed. In other words, a space on an upper side with respect to the pressing part 41a and on a lower side with respect to the protruded part 43e is used as the light passage part 48 where the light emitted from the illumination part 5 and transmitted through the side face part 15b is passed toward an upper face of an information recording medium 2 placed on the glass plate 3.

The contact member 42 is formed of resin. Further, the contact member 42 is separately formed from the pressing member 41 and is disposed on a lower side with respect to the connection part 41c of the pressing member 41. The contact member 42 is, as described above, provided with the contact part 42a. Further, the contact member 42 is provided with a support part 42b which supports the contact part 42a. The contact part 42a is formed in a flat plate shape whose length in the right and left direction is long and is disposed so that a thickness direction of the contact part 42a and the front and rear direction are substantially coincided with each other. The support part 42b is formed in a substantially flat plate shape whose length in the right and left direction is long and is disposed so that a thickness direction of the support part 42b and the upper and lower direction are substantially coincided with each other. The contact part 42a is connected with a front end of the support part 42b. Further, the contact part 42a is extended from the front end of the support part 42b to a lower side.

A width in the right and left direction of the contact part 42a is set to be smaller than the distance in the right and left direction of the two pressing parts 41a. Further, the contact part 42a is disposed between the two pressing parts 41a when viewed in the front and rear direction. A center portion in the right and left direction of an under face of the contact part 42a is, as shown in FIG. 7, formed with a recessed part 42c which is recessed to an upper side. The recessed part 42c is formed in a recessing curved face shape which is a circular arc shape when viewed in the front and rear direction. A width “H” in the right and left direction of the recessed part 42c is set to be smaller than a width in the right and left direction of an ID card 2B (specifically, a width in the right and left direction of an ID card 2B which is placed on the glass 3). Outer sides in the right and left direction of the recessed part 42c are formed to be flat faces substantially perpendicular to the upper and lower direction. In other words, a lower end face of the contact part 42a is formed to be a flat face substantially perpendicular to the upper and lower direction.

Both right and left end faces of the support part 42b are formed with pins 42d which are protruded to outer sides in the right and left direction. The pin 42d is formed in a rear end part of the support part 42b. Further, the pin 42d is formed in a columnar shape. As shown in FIG. 11A and FIG. 11B, the pin 42d is engaged with the recessed part 43n of the holding member 43. Specifically, each of the two pins 42d is inserted into each of the two recessed parts 43n from an inner side in the right and left direction. The contact member 42 is turnable with respect to the holding member 43 with the pin 42d as a center and the right and left direction as an axial direction of turning. In other words, the contact member 42 is held by the holding member 43 so as to be turnable with the right and left direction as an axial direction of turning.

The pressing-up part 41f of the pressing member 41 is contacted with each of both end sides in the right and left direction of the support part 42b from a lower side. The pressing-up part 41f is disposed on a front side with respect to the pin 42d. In other words, the turning center of the contact member 42 with respect to the holding member 43 is disposed on a rear side (back side) with respect to the pressing-up part 41f. Further, the pressing-up part 41f is disposed on a rear side (back side) with respect to the contact part 42a.

In a state that an information recording medium 2 is not inserted into the information reading device 1, the lower end face of the contact part 42a is a flat face perpendicular to the upper and lower direction and is contacted with the upper face of the glass plate 3. Further, in this state, the front face of the contact part 42a is a flat face perpendicular to the front and rear direction. Further, in this state, the front face of the contact part 42a is disposed on a slightly front side with respect to the front end of the connection part 41c of the pressing member 41. A distance between the front end face of the glass plate 3 and the front face of the contact part 42a (distance in the front and rear direction) is set to be shorter than a width in the front and rear direction of a front cover of a passport 2A placed on the glass plate 3 (see FIG. 9A). Further, the distance between the front end face of the glass plate 3 and the front face of the contact part 42a is set to be longer than a width in the front and rear direction of an ID card 2B placed on the glass plate 3 (see FIG. 9B).

In this embodiment, when a passport 2A is begun to be inserted into the information reading device 1, the passport 2A goes into a lower side of the pressing part 41a of the pressing member 41 and the front end side of the pressing part 41a is moved upward (see FIG. 10A). In other words, when a passport 2A is begun to be inserted into the information reading device 1, the front end side of the pressing member 41 is moved upward. Further, when the passport 2A has entered to a predetermined position in the information reading device 1, as shown in FIG. 10B, the pressing-up part 41f is moved upward. Therefore, when the passport 2A has been inserted into the information reading device 1 and entered to a predetermined position, the support part 42b is pushed up by the pressing-up part 41f and the contact member 42 is turned with the pin 42d as a center. Specifically, as shown in FIG. 10B the contact member 42 is turned in a clockwise direction in FIG. 10B and the contact part 42a is moved upward.

As described above, the pressing-up part 41f is disposed on a front side with respect to the turning center of the contact member 42 to the holding member 43 and, in addition, the contact part 42a is disposed on a front side with respect to the pressing-up part 41f. Therefore, a lifted amount of the contact part 42a when the contact part 42a has been moved upward is larger than a lifted amount of the pressing-up part 41f which is lifted by a passport 2A. In other words, a lifted amount of the contact part 42a when a passport 2A is inserted into the information reading device 1 is larger than a lifted amount of the pressing part 41a lifted by the passport 2A and is larger than a thickness of a front cover of the passport 2A. In this embodiment, a lifted amount of the contact part 42a when a passport 2A has been inserted into the information reading device 1 is about three times a lifted amount of the pressing part 41a. Therefore, when a passport 2A has been inserted into the information reading device 1, a rear end (rear end of a front cover) of the passport 2A is passed through a lower side of the contact part 42a and is entered to a rear side with respect to the contact part 42a.

As described above, in this embodiment, when a passport 2A is inserted into the information reading device 1, the pressing parts 41a are moved upward by the passport 2A and press down both end parts in the right and left direction of the passport 2A from an upper side, and the contact part 42a is moved upward and thus a rear end of the passport 2A is passed through the lower side of the contact part 42a. Further, when a passport 2A has been inserted into the information reading device 1, the contact part 42a is moved upward in cooperation with a lifting operation of the pressing part 41a. Specifically, when a passport 2A is inserted into the information reading device 1, the contact member 42 is pushed to an upper side by the pressing member 41 and the contact part 42a is moved upward.

On the other hand, as described above, a width in the right and left direction of an ID card 2B placed on the glass plate 3 is shorter than the distance in the right and left direction of the two pressing parts 41a. Therefore, even when an ID card 2B is inserted into the information reading device 1, the pressing part 41a is not moved upward (in other words, the pressing member 41 is not moved upward) and thus the pressing-up part 41f is not moved upward. Accordingly, even when an ID card 2B is inserted into the information reading device 1, the contact part 42a is not moved upward. Therefore, when an ID card 2B is inserted into the information reading device 1, a rear end of the ID card 2B is contacted with the contact part 42a (see FIG. 3B and FIG. 9B). Specifically, the rear end of the ID card 2B is contacted with the front face of the contact part 42a.

### Information Reading Operation of Information Reading Device

In a case that information recorded in a passport 2A is to be read by the information reading device 1, the passport 2A is inserted into the information reading device 1 so that a rear face of its front cover where personal information is recorded faces a lower side. When a passport 2A is inserted into the information reading device 1, the pressing parts 41a are moved upward by the passport 2A and both end parts in the right and left direction of the passport 2A are pressed down by the pressing parts 41a from an upper side and, in addition, a rear end of the passport 2A is entered into a rear side with respect to the contact part 42a and the passport 2A is placed on the glass plate 3. When the passport 2A is placed on the glass plate 3, the illumination part 4 irradiates it with light to optically read information recorded on the passport 2A. In this case, the shutter 37 is disposed at the second light shielding position 37B. Further, the illumination part 5 does not emit light.

On the other hand, when information recorded on an ID card 2B is to be read by the information reading device 1, the ID card 2B is inserted into the information reading device 1. When an ID card 2B is inserted into the information reading device 1, a rear end of the ID card 2B is contacted with the contact part 42a and the ID card 2B is placed on the glass plate 3. When the ID card 2B is placed on the glass plate 3, first, the illumination part 4 irradiates it with light and information recorded on an under face of the ID card 2B is optically read. In this case, the shutter 37 is disposed at the second light shielding position 37B and the illumination part 5 does not emit light.

When the information recorded on the under face of the ID card 2B has been read, the shutter 37 is moved to the first light shielding position 37A and the illumination part 5 irradiates with light and information recorded on an upper face of the ID card 2B is optically read. In this case, the illumination part 4 does not emit light. In a case that information recorded on the ID card 2B is to be read, it may be structured that, after information recorded on an upper face of the ID card 2B has been read, information recorded on an under face of the ID card 2B is read.

### Principal Effects in this Embodiment

As described above, in this embodiment, when a passport 2A is inserted into the information reading device 1, the pressing parts 41a of the pressing member 41 are moved upward by the passport 2A and both end parts in the right and left direction of the passport 2A are pressed down from an upper side. Therefore, according to this embodiment, even if an end part of a passport 2A is folded or the like, when information recorded on an under face of the passport 2A is to be optically read, both end parts in the right and left direction of the passport 2A are pressed down from an upper side and floating of the under face of the passport 2A from an upper face of the glass plate 3 can be suppressed. Further, even when an end part of a passport 2A has been folded or the like, floating of an under face of the passport 2A from the upper face of the glass plate 3 can be suppressed and thus, occurrence of glare in an image of the under face of the passport 2A can be suppressed. In other words, in this embodiment, in a case that a face where gloss processing is performed by coating material like a rear face of a front cover of a passport 2A in compliance with International Civil Aviation Organization (ICAO) is to be read, unnecessary reflection which is occurred from an end face of the coating material of the rear face of the front cover of the passport 2A due to folding or the like in a rear end portion of both end parts in the right and left direction of the passport can be suppressed. Therefore, characters for character recognition recorded on rear end portions of both end parts in the right and left direction of the passport 2A can be read adequately and character recognition processing can be performed adequately. Further, in this embodiment, influence such as halation or black crushing due to an excessive light quantity or an insufficient light quantity on information recorded on an under face of a passport 2A whose end part is easily folded or the like can be suppressed, and information recorded on the under face of the passport 2A can be optically read adequately.

Further, a passport 2A in this embodiment is a passport prepared along the guideline of the International Civil Aviation Organization. In this embodiment, the pressing parts 41a are contacted with substantially the entire both end parts in the right and left direction of a passport 2A placed on the glass plate 3 from an upper side to press down substantially the entire both end parts in the right and left direction of the passport 2A from the upper side, and rear end portions of both end parts in the right and left direction of the passport 2A are also pressed down from the upper side by the pressing parts 41a. Therefore, according to this embodiment, characters for character recognition recorded on rear end portions of both end parts in the right and left direction of a passport 2A can be read adequately to perform character recognition processing adequately.

In this embodiment, when a passport 2A is inserted into the information reading device 1, the contact part 42a is moved upward and a rear end of the passport 2A is passed through a lower side with respect to the contact part 42a. Therefore, even when a distance between a front end face of the glass plate 3 and a front face of the contact part 42a is set to be shorter than a width in the front and rear direction of a front cover of the passport 2A placed on the glass plate 3, the passport 2A can be inserted to a predetermined position in the front and rear direction and, as a result, information recorded on an under face of the passport 2A can be read optically and adequately.

In this embodiment, a distance in the right and left direction of the two pressing parts 41a is set to be wider than a width in the right and left direction of an ID card 2B. Further, in this embodiment, when an ID card 2B is inserted into the information reading device 1, a rear end of the ID card 2B is contacted with a front face of the contact part 42a which is disposed on a front side with respect to a front end of the connection part 41c of the pressing member 41. Therefore, according to this embodiment, when information recorded on an upper face of an ID card 2B is to be read optically, the ID card 2B can be positioned in the front and rear direction at a position where an image of the pressing member 41 is not captured. Accordingly, in this embodiment, information recorded on an upper face of an ID card 2B can be optically read adequately. Further, an end part of an ID card 2B is hard to be bent and thus, in this embodiment, even when an ID card 2B is not pressed down from an upper side, information recorded on an under face of the ID card 2B can be optically read adequately. Therefore, according to this embodiment, information recorded on both faces of an ID card 2B whose end part is hard to be bent and whose size is smaller than a passport 2A can be optically read adequately.

In this embodiment, a lifted amount of the contact part 42a when a passport 2A is inserted into the information reading device 1 is larger than a lifted amount of the pressing part 41a which is moved upward by the passport 2A. Therefore, according to this embodiment, even when a deformed amount of an end part of a passport 2A is large, contact of a rear end of the passport 2A inserted into the information reading device 1 with the contact part 42a can be prevented. Accordingly, in this embodiment, even when a deformed amount of an end part of a passport 2A is large, a rear end of the passport 2A can be inserted to a rear side with respect to the contact part 42a.

Further, in this embodiment, the recessed part 42c is formed in a center portion in the right and left direction of an under face of the contact part 42a and thus, even when a center part in the right and left direction of a rear end part of a passport 2A whose both end parts in the right and left direction are pressed down by the pressing parts 41a is largely deformed, contact of the rear end of the passport 2A inserted into the information reading device 1 with the contact part 42a can be prevented. Therefore, according to this embodiment, even when a center part in the right and left direction of a rear end part of a passport 2A whose both end parts in the right and left direction are pressed down is largely deformed, the rear end of the passport 2A can be inserted to a rear side with respect to the contact part 42a.

In this embodiment, when a passport 2A is inserted into the information reading device 1, the pressing member 41 is moved upward by the passport 2A. Therefore, according to this embodiment, in comparison with a case that a mechanism for moving the pressing member 41 upward is separately provided, a structure of the information reading device 1 can be simplified. Further, in this embodiment, when a passport 2A is inserted into the information reading device 1, the contact member 42 is pushed to an upper side by the pressing member 41 which is moved upward by the passport 2A, and the contact part 42a is moved upward. Therefore, according to this embodiment, in comparison with a case that a mechanism for moving the contact part 42a upward is separately provided, a structure of the information reading device 1 can be simplified.

In this embodiment, an upper face of the pressing-up part 41f is formed in a protruding curved face shape which is a circular arc shape when viewed in the right and left direction. Further, in this embodiment, when viewed in the right and left direction, the pressing-up part 41f is disposed directly below the guide pin 41g. Therefore, according to this embodiment, even when the pressing member 41 is turned and inclined with the guide pin 41g as a center, a contact position of the pressing-up part 41f with the contact member 42 in the upper and lower direction is hard to be varied. In other words, when viewed in the right and left direction, as shown by the two-dot chain lines in FIG. 11B, in a case that the pressing-up part 41f disposed on a lower side with respect to the guide pin 41g is disposed on a front side with respect to the guide pin 41g or disposed on a rear side with respect to the guide pin 41g, when the pressing member 41 is turned and inclined with the guide pin 41g as a center, a contact position of the pressing-up part 41f with the contact member 42 in the upper and lower direction is varied (see FIG. 11B). However, according to this embodiment, the contact position of the pressing-up part 41f with the contact member 42 in the upper and lower direction is hard to be varied. Therefore, in this embodiment, even when the pressing member 41 is turned and inclined with the guide pin 41g as a center, variation of a lifted amount of the contact part 42a can be reduced.

In this embodiment, when a passport 2A is not inserted into the information reading device 1, the holding member 43 is contacted with an under face of the upper face part 15a and the pressing member 41 is contacted with an upper face of the glass plate 3 by urging forces of the compression coil springs 44 and 45. Therefore, according to this embodiment, the medium pressing mechanism 12 can be detached from the medium arrangement part 16 by resiliently bending the compression coil springs 44 and 45. In other words, in this embodiment, the medium pressing mechanism 12 can be easily detached from the medium arrangement part 16. Further, in this embodiment, an upper face of the glass plate 3 can be easily cleaned by detaching the medium pressing mechanism 12 from the medium arrangement part 16.

In this embodiment, an upper side with respect to the pressing part 41a and a lower side with respect to the protruded part 43e is the light passage part 48 through which light emitted from the illumination part 5 and transmitted through the side face part 15b is passed toward an upper face of an information recording medium 2 placed on the glass plate 3. Therefore, according to this embodiment, even when the pressing member 41 structured to press down both end parts in the right and left direction of a passport 2A is provided, an upper face of the information recording medium 2 placed on the glass plate 3 can be adequately irradiated with light.

Further, in this embodiment, the upper face 41e of the pressing part 41a is formed to be an inclined face which is inclined toward a lower side as going to an inner side in the right and left direction and thus, lights of the illumination parts 5 irradiated from outer sides in the right and left direction and from obliquely upper side toward an information recording medium 2 placed on the glass plate 3 are hard to be blocked by the pressing parts 41a. Further, the upper face 41e is formed to be an inclined face which is inclined toward a lower side as going to an inner side in the right and left direction and thus, an ID card 2 inserted into the information reading device 1 can be guided between the two pressing parts 41a by utilizing the upper face 41e.

### Other Embodiments

Although at least an embodiment of the present invention has been shown and described with reference to a specific embodiment, various changes and modifications will be apparent to those skilled in the art from the teachings herein.

In the embodiment described above, it may be structured that the pressing part 41a contacts from an upper side with a part of each of both end parts in the right and left direction of a passport 2A placed on the glass plate 3, and that the parts of both end parts in the right and left direction of the passport 2A are pressed down from the upper side. In this case, when a passport 2A is a passport prepared along the guideline of the International Civil Aviation Organization, the pressing parts 41a are contacted from an upper side with at least rear end portions of both end parts in the right and left direction of the passport 2A, and the pressing parts 41a press down at least the rear end portions of both end parts in the right and left direction of the passport 2A from the upper side.

In the embodiment described above, an urging force of the compression coil spring 44 may be set stronger than an urging force of the compression coil spring 45. In this case, after a passport 2A is begun to be inserted into the information reading device 1, at an earlier stage, a front end side of the pressing member 41 can be moved downward and a rear end side of the pressing member 41 is moved upward. In other words, after a passport 2A is begun to be inserted into the information reading device 1, at an earlier stage, the pressing-up part 41f can be moved upward. Therefore, after a passport 2A is begun to be inserted into the information reading device 1, at an earlier stage, the contact part 42a can be pushed upward by the pressing-up part 41f Accordingly, contact of a rear end of a passport 2A inserted into the information reading device 1 with the contact part 42a is easily and further surely prevented.

In this case, the compression coil spring 44 is a first compression coil spring disposed on a front end side of the holding member 43 and the compression coil spring 45 is a second compression coil spring disposed on a rear end side (back end side) of the holding member 43. Further, the pressing member 41 may be formed so that a center of gravity of the pressing member 41 is located at a further front side. Also in this case, after a passport 2A is begun to be inserted into the information reading device 1, at an earlier stage, a front end side of the pressing member 41 is moved downward and a rear end side of the pressing member 41 can be moved upward. Therefore, contact of a rear end of a passport 2A inserted into the information reading device 1 with the contact part 42a is easily and further surely prevented.

In the embodiment described above, the pressing part 41a may be structured so as to be turnable with respect to the holding member 43 with the front and rear direction as an axial direction of turning. In this case, the pressing-up part 41f is disposed on an inner side in the right and left direction with respect to a turning center of the pressing part 41a to the holding member 43. Further, in the embodiment described above, the pressing member 41 and the contact member 42 may be integrally formed each other. In this case, for example, the whole or a part of the pressing member 41 and the contact member 42 integrally formed each other may be formed of rubber.

In the embodiment described above, it may be structured that the contact part 42a is not moved upward in cooperation with a lifting operation of the pressing part 41a. For example, it may be structured that the medium pressing mechanism 12 includes a member which is pushed by a rear end of a passport 2A inserted into the information reading device 1 to be moved or turned, and that the contact part 42a is moved upward in cooperation with the movement of the member. In other words, it may be structured that the contact member 42 is pushed to an upper side by the member to make the contact part 42a move upward. Further, it may be structured that the medium pressing mechanism 12 includes a drive source structured to turn the contact member 42 and a detection mechanism structured to detect a rear end of a passport 2A, and that, based on a detection result of the detection mechanism, the contact member 42 is turned to make the contact part 42a move upward.

In the embodiment, the medium pressing mechanism 12 may include a lifting mechanism structured to raise and lower the pressing member 41. In this case, when a passport 2A is inserted into the information reading device 1, the pressing member 41 located at an upward position is lowered to press down both end parts in the right and left direction of the passport 2A from an upper side. Further, in the embodiment described above, a lifted amount of the contact part 42a when a passport 2A is inserted into the information reading device 1 may be equal to a lifted amount of the pressing part 41a which is moved upward by the passport 2A. In this case, for example, the contact member 42 is held by the holding member 43 so as to be slidable in the upper and lower direction. Further, in this case, for example, the pressing member 41 and the contact member 42 are integrally formed each other.

In the embodiment described above, the pressing member 41 may be urged to a lower side by another spring member separately provided from the compression coil springs 44 and 45. Further, in the embodiment described above, the medium pressing mechanism 12 may include no compression coil springs 44 and 45. In this case, the protruded parts 43e of the holding member 43 are not required. Further, in this case, the pressing member 41 which has been moved upward by a passport 2A is lowered by its own weight when a passport 2A is pulled out. Further, in the embodiment described above, the medium pressing mechanism 12 may be fixed in an inside of the medium arrangement part 16.

In the embodiment described above, instead of the guide pin 41g, a guide pin separately formed from the pressing member 41 may be fixed to the pressing member 41. Further, in the embodiment described above, it may be structured that a guide groove corresponding to the guide groove 43j is formed in the pressing member 41, and a guide pin corresponding to the guide pin 41g is formed or fixed to the holding member 43. In addition, in the embodiment described above, the pressing-up part 41f may not be disposed directly below the guide pin 41g. Further, in the embodiment described above, the upper face 41e of the pressing part 41a may not be inclined and an under face of the contact part 42a may not be formed with the recessed part 42c.

In the embodiment described above, instead of the beam splitter 13, a reflection mirror may be provided which is turned between a position where light passed through the optical system 6 is passed toward the image-forming optical system 9 and a position where light passed through the optical system 7 is reflected toward the image-forming optical system 9. The reflection mirror is, for example, similarly to a reflection mirror of a single lens reflex camera, turned by 45° with the right and left direction as an axial direction of turning. In this case, the shutter mechanism 14 is not required.

In the embodiment described above, the optical systems 6 and 7 may be structured so that the beam splitter 13 reflects a part of light passed through the optical system 6 toward the image-forming optical system 9 and transmits a part of light passed through the optical system 7 toward the image-forming optical system 9. Further, in the embodiment described above, an image-forming optical system to which light passed through the optical system 6 is made incident and its image pickup element may be separately provided from an image-forming optical system to which light passed through the optical system 7 is made incident and its image pickup element. In addition, in the embodiment described above, the information reading device 1 may be, for example, provided with a transparent resin plate such as an acrylic plate instead of the glass plate 3.

In the embodiment described above, no IC chip may be incorporated in an information recording medium 2. In this case, an antenna disposed on a lower side of the glass plate 3 and the antenna 17 are not required. Further, in the embodiment described above, the information recording medium 2 may be a medium other than a passport 2A and an ID card 2B. For example, the information recording medium 2 may be a driver's license. In addition, in the embodiment described above, the information reading device 1 is a manual type reading device. However, an information reading device to which the structure of at least an embodiment of the present invention is applied may be a medium conveyance type reading device including a conveyance mechanism for an information recording medium.

In the present specification, the second information recording medium includes various cards such as “TD1” (Machine Readable Travel Documents) complying with a passport standard by International Civil Aviation Organization (ICAO), a card complying with ID-1 of International Standard Organization (ISO), a driver's license, a Permanent Resident Card, and an ID card of U.S. armed forces.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

### REFERENCE SIGNS LIST

1 information reading device
2 information recording medium
2A passport (first information recording medium)
2B ID card (second information recording medium)
3 glass plate (placement member)
4 illumination part (first illumination part)
5 illumination part (second illumination part)
6 optical system (first optical system)
7 optical system (second optical system)
15 cover member
15a upper face part
41 pressing member
41a pressing part
41c connection part
41e upper face (upper face of pressing part)
41f pressing-up part
41g guide pin
42 contact member
42a contact part
42c recessed part
43 holding member
43j guide groove
44 compression coil spring (urging member, first compression coil spring)
45 compression coil spring (urging member, second compression coil spring)
48 light passage part
“X” right and left direction
“Y” front and rear direction
“Y1” front side
“Y2” rear side

1. An information reading device structured to optically read information recorded on an information recording medium, the information reading device comprising:
a placement member which is transparent and on which the information recording medium is placed;
a first illumination part structured to irradiate an under face of the information recording medium placed on the placement member with light;
a second illumination part structured to irradiate an upper face of the information recording medium placed on the placement member with light;
a first optical system structured to read information recorded on the under face of the information recording medium placed on the placement member; and
a second optical system structured to read information recorded on the upper face of the information recording medium placed on the placement member;
wherein when an inserting direction side of the information recording medium to the information reading device is defined as a rear side, a taking-out direction side of the information recording medium from the information reading device is defined as a front side, an insertion taking-out direction of the information recording medium with respect to the information reading device is defined as a front and rear direction, and a direction perpendicular to an upper and lower direction and the front and rear direction is defined as a right and left direction, the information reading device further comprising:
a pressing member comprising two pressing parts structured to contact from an upper side with at least parts of both end parts in the right and left direction of a first information recording medium as the information recording medium to press down at least the parts of the both end parts in the right and left direction of the first information recording medium; and
a contact member comprising a contact part structured to contact with a rear end of a second information recording medium as the information recording medium;
wherein a width in the front and rear direction of a portion of the first information recording medium placed on the placement member is wider than a width in the front and rear direction of a portion of the second information recording medium placed on the placement member;
wherein a distance in the right and left direction of the two pressing parts is wider than a width in the right and left direction of the second information recording medium;
wherein when the first information recording medium is inserted into the information reading device, the pressing parts press down at least the parts of the both end parts in the right and left direction of the first information recording medium from the upper side and the contact part is moved upward to allow a rear end of the first information recording medium to pass a lower side with respect to the contact part; and
wherein when the second information recording medium is inserted into the information reading device, a rear end of the second information recording medium contacts with the contact part.

2. The information reading device according to claim 1, wherein the pressing parts press down at least rear end portions of the both end parts in the right and left direction of the first information recording medium from the upper side.

3. The information reading device according to claim 1, wherein when the first information recording medium is inserted into the information reading device, the pressing parts are moved upward by the first information recording medium to press down at least the parts of the both end parts in the right and left direction of the first information recording medium from the upper side.

4. The information reading device according to claim 3, wherein a lifted amount of the contact part when the first information recording medium has been inserted into the information reading device is larger than a lifted amount of the pressing part which is moved upward by the first information recording medium.

5. The information reading device according to claim 4, wherein when the first information recording medium is inserted into the information reading device, the contact part is moved upward in cooperation with a lifted operation of the pressing part.

6. The information reading device according to claim 5, wherein
the pressing member and the contact member are separately provided from each other, and
when the first information recording medium is inserted into the information reading device, the contact member is pushed to an upper side by the pressing member and the contact part is moved upward.

7. The information reading device according to claim 6, further comprising a holding member which holds the contact member so that the contact member is turnable with the right and left direction as an axial direction of turning,
wherein one of the holding member and the pressing member is formed or fixed with a guide pin for guiding the pressing member in the upper and lower direction with respect to the holding member so that the guide pin is protruded in the right and left direction, and
wherein an other of the holding member and the pressing member is formed with a guide groove with which the guide pin is engaged.

8. The information reading device according to claim 7, wherein
the pressing member is turnable with respect to the holding member with the guide pin as a center and with the right and left direction as an axial direction of turning,
the pressing member is formed with a pressing-up part structured to contact with the contact member from a lower side to push up the contact part, and
when viewed in the right and left direction, the pressing-up part is disposed directly below the guide pin.

9. The information reading device according to claim 8, wherein an upper face of the pressing-up part is formed to be a protruding curved face shape which is a circular arc shape when viewed in the right and left direction.

10. The information reading device according to claim 7, further comprising:
a cover member comprising an upper face part which is transparent and disposed on an upper side with respect to the information recording medium placed on the placement member, and
an urging member which urges the pressing member to a lower side with respect to the holding member,
wherein the holding member is contacted with an under face of the upper face part, and
wherein when the first information recording medium is not inserted into the information reading device, the pressing member is contacted with the upper face of the placement member.

11. The information reading device according to claim 10, further comprising:
a first compression coil spring as the urging member which is disposed on a front end side of the holding member, and
a second compression coil spring as the urging member which is disposed on a rear end side of the holding member,
wherein the pressing member is formed with a pressing-up part structured to contact with the contact member from the lower side to push the contact part upward,
wherein the pressing-up part is disposed on a rear side with respect to the contact part,
wherein a turning center of the contact member with respect to the holding member is disposed on a rear side with respect to the pressing-up part, and
wherein an urging force of the first compression coil spring is stronger than an urging force of the second compression coil spring.

12. The information reading device according to claim 1, wherein
the pressing member comprises the two pressing parts which are formed in a straight shape parallel to the front and rear direction and a connection part which connects rear end parts of the two pressing parts, and
an upper side of the pressing part is a light passage part through which light emitted from the second illumination part is passed.

13. The information reading device according to claim 12, wherein an upper face of the pressing part is formed to be an inclined face which is inclined to a lower side as going to an inner side in the right and left direction.

14. The information reading device according to claim 1, wherein
a center portion in the right and left direction of an under face of the contact part is formed with a recessed part which is recessed to an upper side, and
a width in the right and left direction of the recessed part is set to be narrower than the width in the right and left direction of the second information recording medium.

15. The information reading device according to claim 14, wherein the recessed part is formed in a recessing curved face shape which is a circular arc shape when viewed in the front and rear direction.

16. The information reading device according to claim 7, wherein
the pressing member comprises the two pressing parts which are formed in a straight shape parallel to the front and rear direction and a connection part which connects rear end parts of the two pressing parts, and
an upper side of the pressing part is a light passage part through which light emitted from the second illumination part is passed.

17. The information reading device according to claim 16, wherein an upper face of the pressing part is formed to be an inclined face which is inclined to a lower side as going to an inner side in the right and left direction.

18. The information reading device according to claim 7, wherein
a center portion in the right and left direction of an under face of the contact part is formed with a recessed part which is recessed to an upper side, and a width in the right and left direction of the recessed part is set to be narrower than the width in the right and left direction of the second information recording medium.

19. The information reading device according to claim 18, wherein the recessed part is formed in a recessing curved face shape which is a circular arc shape when viewed in the front and rear direction.
